(19) United States
(12) Patent Application Publication
(10) Pub. No.: US 2018/0298874 A1
(43) Pub. Date: Oct. 18, 2018

(54) PUMPED HYDROELECTRIC ENERGY STORAGE

(71) Applicant: Logan Michael Turk, Jupiter, FL (US)

(72) Inventor: Logan Michael Turk, Jupiter, FL (US)

(21) Appl. No.: 15/956,728

(22) Filed: Apr. 18, 2018

Related U.S. Application Data
(60) Provisional application No. 62/486,964, filed on Apr. 18, 2017.

(51) Int. Cl. F03B 13/06; F03B 11/02; F03B 15/14

(52) U.S. Cl. CPC F03B 13/06; F03B 15/14; F03B 11/02

(57) ABSTRACT

A vessel may be disposed in a body of water. At equilibrium, the water level inside the vessel may be equal to the water level of the body of water. Water may be forced through an outlet from the vessel into the body of water, which decreases the water level inside the vessel. A valve on the outlet may be closed to store the potential energy of the system. When energy is desired, a valve may be opened. Water may flow into the vessel through an inlet, turn a turbine, and generate electricity.

### CROSS-REFERENCE TO RELATED APPLICATION

This application claims the benefits of U.S. Provisional Application No. 62/486,964 filed Apr. 18, 2017 by Logan Michael Turk and entitled “Pumped Hydroelectric Energy Storage” under 35 U.S.C. § 119(e) and the entire contents of that application are expressly incorporated herein by reference thereto.

### FIELD OF THE INVENTION

The invention is related to hydroelectric energy. In particular, the invention is related to pumping of fluid between locations such that potential energy is converted into electrical energy. Specifically, the invention is related to pumped hydroelectric energy storage.

### BACKGROUND OF THE INVENTION

It is well-known that it is difficult to store a substantial amount of energy, for example 100 kWh, in a cost-effective manner. It is even more problematic to store megawatt-hours of energy, for example to release to the energy grid when consumption demands are high. Energy storage can help integrate intermittent energy generation into the grid, and assist in matching supply with demand on the grid. This problem has been addressed successfully in the past using pumped hydroelectric storage (PHS). Conventional PHS requires two water reservoirs which are separated by a height difference. To store electricity, water is pumped from the lower reservoir to the upper reservoir. When electricity is required, the water from the upper reservoir is allowed to flow back into the lower reservoir to turn a turbine and produce electricity. This technology is limited to a small number of locations which have two reservoirs of water near each other and also have an appreciable height difference between them. Traditional PHS sites also occupy a significant land area, which restricts man-made reservoirs from being built to expand the use of the technology.

A method of storing and producing energy is disclosed in prior U.S. Pat. No. 4,321,475. However, as understood, an optimal shape and building materials for pumped hydroelectric energy storage (pumped hydro) in a single body of water are not disclosed.

According to data through mid-2016 in the U.S. Department of Energy (DOE) Global Energy Storage Database, pumped hydro dominates the market for energy storage with over 160,000 MW of installed capacity. Liquid energy storage, hydrogen storage, electro-mechanical storage, thermal storage, and electro-chemical storage each account for two to five orders of magnitude less storage. Yet the number of global project installations of pumped hydro has largely been stagnant since 1995. The stagnant growth is due to a variety of factors, notably geographic constraints, environmental impact, and difficulty obtaining licenses and permits. Yet the storage market has been projected to be $1.5 billion/year by 2019 with substantial opportunity for further growth expected if the issues concerning geographic constraints, environmental impact, and other regulatory requirements can be overcome.

There remains a need for pumped hydroelectric energy storage that employs preferred vessel shape(s), preferred building material(s), and/or operates in a single body of water.

### SUMMARY OF THE INVENTION

The invention relates to a method of converting energy comprising: storing a first volume of liquid in a vessel in communication with an atmosphere, wherein the first volume of liquid extends within the vessel to proximate a surface of a surrounding body of liquid; removing at least a portion of the first volume from the vessel into the body of liquid through an opening proximate a second end thereof, leaving a second volume of liquid in the vessel; restricting flow of liquid into the vessel; permitting flow of liquid into the vessel while passing through a turbine connected to a generator; transmitting electrical energy generated by the generator.

The body of liquid may be at least 10,000 gallons. The liquid may be removed from the vessel with a pump. The vessel may be tapered from a first end proximate the surface of the surrounding body of liquid to the second end remote from the surface of the surrounding body of liquid. Energy may be transmitted along a high voltage line. The body of liquid may be selected from the group consisting of a pool, a pond, a lake, a sea, a gulf, a bay, and an ocean. The liquid may be fresh water or salt water. The atmosphere may be at sea level. In some embodiments, the vessel may be cylindrical or may have an elliptical cross-section. In addition, a valve may be used to restrict flow. Also, the surface of the body of water may be disposed proximate sea level. The vessel may be formed from concrete, and the vessel may be attached to a floor for the surrounding body of liquid such as the ocean floor.

The invention further relates to a method of converting energy between states comprising: using electrical energy to power a pump; using the pump to remove liquid from a storage space; spinning a turbine-generator while removing the liquid from the storage space; and using the turbine-generator to convert mechanical energy to electrical energy to be transmitted on a high voltage line. In some embodiments, the high voltage line, which for example connects the energy storage system to the United States energy transmission grid, may be rated for at least 11,000 volts for transmission.

Furthermore, the invention relates to a method of varying head space to generate electricity on demand comprising: creating a first head space in a tubular member with an open end proximate a surface of a surrounding body of liquid disposed adjacent the open end; and creating a second head space substantially larger than the first head space by removing liquid from the tubular member. The surrounding body of liquid may be selected from the group consisting of a pool, a pond, a lake, a sea, a gulf, a bay, and an ocean. In some embodiments, the tubular member may be cylindrical and in others, the tubular member may have an elliptical cross-section. The vessel may be tapered from a first end to a second end.

The invention may be used to collect energy generated by multiple offshore wind turbines or solar panels. Further, the invention may control the amount of energy delivered to the grid from the wind turbines or solar panels.

The invention also may relate to a method of regulating the flow of energy supplied by offshore energy generators, which may include wind turbines, aerial wind turbines, photovoltaic solar panels, solar panels, floating solar panels, floating nuclear energy plants, and/or offshore nuclear energy plants, whereby electrical energy may be converted into gravitational potential energy, stored, and then when desired, converted into electrical energy to be transmitted to energy customers on land.

### BRIEF DESCRIPTION OF THE DRAWINGS

Preferred features of the invention are disclosed in the accompanying drawings, wherein:

FIG. 1 shows a side cross-section of the equilibrium state of an energy storage system, with fluid inside and outside the vessel being at about the same level; and

FIG. 2 shows a side cross-section of the state of the system of FIG. 1 when energy is being stored.

### DETAILED DESCRIPTION OF THE PREFERRED EMBODIMENTS

In one embodiment, the invention converts electrical energy to gravitational potential energy for storage, and then converts the gravitational potential energy back into electrical energy when desired. This process can be repeated numerous times over its lifetime.

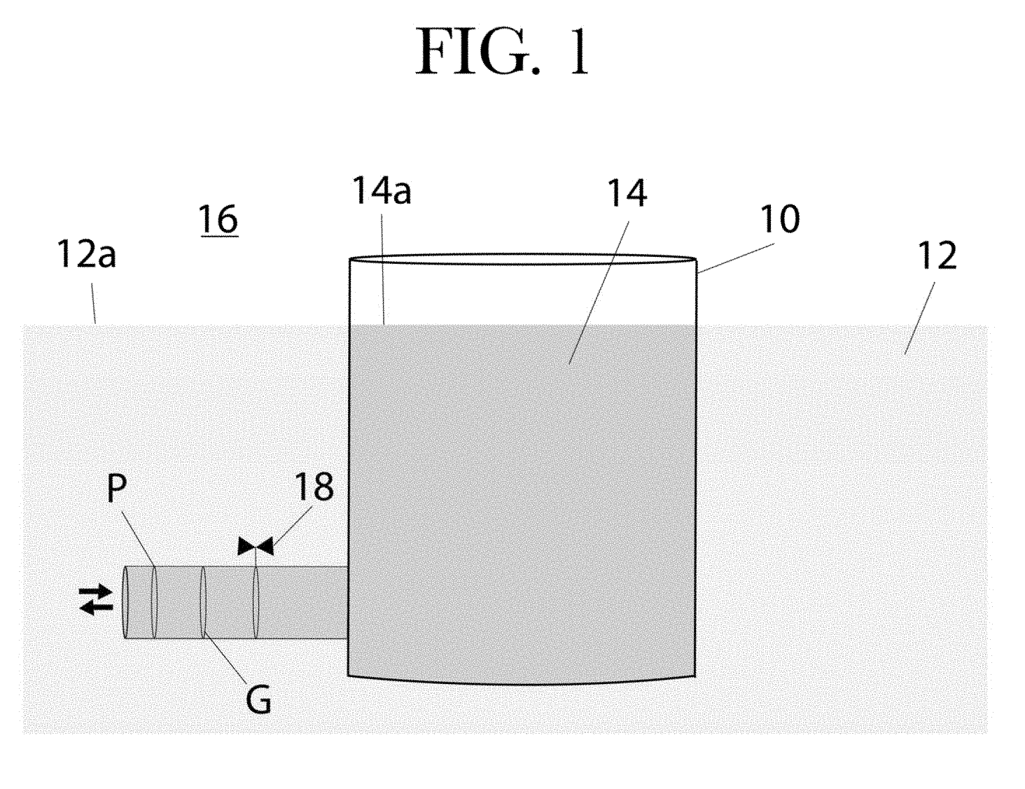

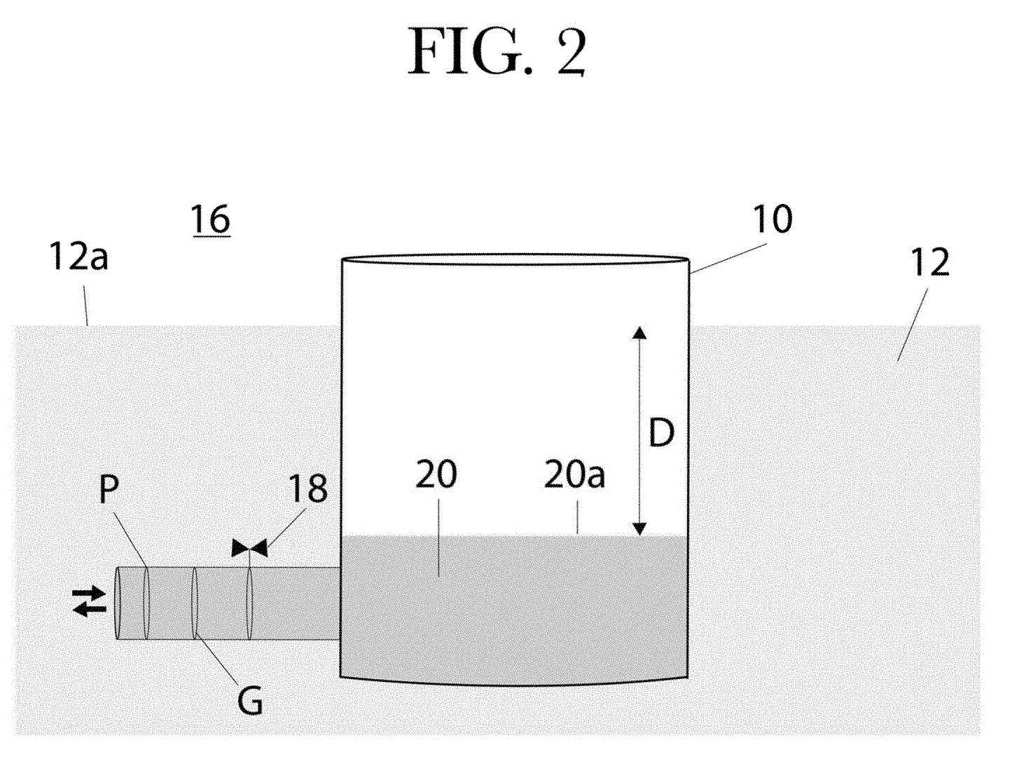

As shown in FIGS. 1 and 2, a cylindrical storage space 10 is disposed in a body of liquid 12, such that storage space 10 stores a first volume of liquid 14 in communication with an atmosphere 16. The first volume of liquid 14 extends within storage space 10, e.g., a cylindrical vessel or tank, so as to have a surface 14a proximate a surface 12a of the surrounding body of liquid 12. In other words, initially, water for example inside the vessel is at approximately the same surface level as the surface level of the surrounding body of liquid such as an ocean. A valve 18 is disposed proximate a lower portion of storage space 10, so that when energy is supplied to the system, at least a portion of first volume of liquid 14 may be removed from storage space 10, such as by pumping using a pump P, and into body of liquid 12 through an opening (e.g., a pipe) proximate a second end thereof, leaving a second volume of liquid 20 in storage space 10. Surface 20a of second volume of liquid 20 is no longer proximate surface 12a of the surrounding body of liquid 12. The result is a height difference D (the difference in height between the emptied portion of storage space 10 and the external body of liquid 12, which for example is water) between the second volume of liquid 20 and body of liquid 12. Valve 18 may be closed to store the potential energy resulting from height difference D. Then, when energy is desired to be transmitted to the grid, valve 18 may be opened to permit liquid from body of liquid 12 to flow into storage space 10, with the flowing liquid turning a generator G to produce power.

In another embodiment, an optimal storage vessel may have an ellipse-shaped cross-section when taken perpendicular to the direction of gravity. For example, a cylindrical, near-cylindrical, or spherical shaped vessel may be disposed proximate the bottom or lowermost point of the body of water. The vessel may maintain a constant diameter along its height, or vary its diameter along the direction of gravity to employ a smaller opening to the atmosphere. Liquid may pumped out of the vessel from an orifice separate from the exit which communicates with the turbine-generator.

Construction materials may include, for example, concrete, cement, or another similar aggregate-based material. The concrete, cement, or other aggregate-based material may be reinforced by steel, metal or other reinforcement for added structural integrity and/or strength. Methods of construction for example may utilize a slip-form to pour the concrete or aggregate-based material into the desired shape. The construction methods can be performed on land and transported into the surrounding liquid, or performed within the surrounding liquid.

Examples of bodies of water in which the invention may be deployed include oceans, seas, and large lakes, which may include, but are not limited to, the Atlantic Ocean, Pacific Ocean, Gulf of Mexico, Indian Ocean, Mediterranean Sea, and the Great Lakes.

Approximately forty percent of the world's population lives in coastal communities, and ocean covers approximately seventy percent of the world. Thus, pumped hydro advantageously can be sited in the ocean.

Pumped hydro advantageously permits flexible siting, an economical alternative to other energy storage technologies such as lithium ion and flow batteries, and enables dispatchable, reliable offshore wind energy integration. To these ends, the invention, for example, may be used to store excess energy from power generating stations on land, and energy generated by wind turbines, aerial wind turbines, solar panels, and other sources of intermittent energy located offshore.

For grid-scale storage, conventional pumped hydro, e.g., not sited in a large body of water, offers constant storage capacity, long design life, and stable supply chain. Advantageously, the inventive pumped hydro energy storage disclosed herein meets a long felt but unsolved need of allowing site flexibility which is otherwise unachievable with conventional pumped hydro given geographic constraints, environmental impact, and regulatory challenges. Moreover, while lithium ion storage, for example, can offer siting flexibility, it cannot offer storage capacity that does not materially diminish during its lifetime, long design lifetimes for example greater than 20 years, or a supply chain less affected by fluctuating commodity prices such as for lithium, cobalt, and other precious metals.

Multiple energy storage devices may be disposed in an arrangement near each other. The devices may share a common platform on which solar panels, control systems, and living quarters for plant operators (if appropriate) may be located.

It may be desirable to use the energy storage device to anchor aerial wind turbines and wind energy generators. The structure may also be used as the base for stationary wind turbines. As yet another use of the structure, it may serve as a support structure for solar energy harvesting devices such as solar photovoltaic panels. Various combinations of the energy storage device with wind turbines, aerial wind generators, solar panels, tidal power, wave power, and other energy generation sources may create offshore Renewable Energy Centers where energy is generated and stored for use.

In one embodiment, the invention allows pumped hydroelectric storage to be implemented using a single body of water. Storage vessels may be disposed in a large body of water, including but not limited to, oceans, seas, and lakes. Energy supplied to the system may be used to pump water out of the vessel, leaving an evacuated space or volume. In this example, electrical energy is converted to gravitational potential energy. The evacuated portion of the vessel creates a height difference between the water inside the vessel and the external body of water. A valve or other flow restriction device may be used to store the potential energy. Energy may be generated by allowing water to flow from the external body of water into the vessel. One exemplary method of energy generation is turning a turbine connected to a generator to produce electrical energy.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A method of converting energy comprising:
storing a first volume of liquid in a vessel in communication with an atmosphere, wherein the first volume of liquid extends within the vessel to proximate a surface of a surrounding body of liquid;
removing at least a portion of the first volume from the vessel into the body of liquid through an opening proximate a second end thereof, leaving a second volume of liquid in the vessel;
restricting flow of liquid into the vessel;
permitting flow of liquid into the vessel while passing through a turbine connected to a generator;
transmitting electrical energy generated by the generator.

2. The method of claim 1, wherein the body of liquid comprises at least 10,000 gallons.

3. The method of claim 1, where the liquid is removed from the vessel with a pump.

4. The method of claim 1, wherein the vessel is tapered from a first end proximate the surface of the surrounding body of liquid to the second end remote from the surface of the surrounding body of liquid.

5. The method of claim 1, wherein energy is transmitted along a high voltage line.

6. The method of claim 1, wherein the body of liquid is selected from the group consisting of a pool, a pond, a lake, a sea, a gulf, a bay, and an ocean.

7. The method of claim 1, wherein the liquid is fresh water.

8. The method of claim 1, wherein the liquid is salt water.

9. The method of claim 1, wherein the atmosphere is at sea level.

10. The method of claim 1, wherein the vessel is cylindrical.

11. The method of claim 1, wherein the vessel has an elliptical cross-section.

12. The method of claim 1, wherein a valve is used to restrict flow.

13. The method of claim 1, wherein the surface of the body of water is disposed proximate sea level.

14. The method of claim 1, wherein the vessel is formed from concrete.

15. The method of claim 1, wherein the vessel is attached to a floor for the surrounding body of liquid.

16. A method of converting energy between states comprising:
using electrical energy to power a pump;
using the pump to remove liquid from a storage space;
spinning a turbine-generator while removing the liquid from the storage space;
using the turbine-generator to convert mechanical energy to electrical energy to be transmitted on a high voltage line.

17. The method of claim 16, wherein the high voltage line is rated for at least 11,000 volts for transmission.

18. A method of varying head space to generate electricity on demand comprising:
creating a first head space in a tubular member with an open end proximate a surface of a surrounding body of liquid disposed adjacent the open end;
creating a second head space substantially larger than the first head space by removing liquid from the tubular member.

19. The method of claim 18, wherein the surrounding body of liquid is selected from the group consisting of a pool, a pond, a lake, a sea, a gulf, a bay, and an ocean.

20. The method of claim 18, wherein the tubular member is cylindrical.

21. The method of claim 18, wherein the tubular member has an elliptical cross-section.

22. The method of claim 18, wherein the vessel is tapered from a first end to a second end.
